(19) United States
(12) Patent Application Publication
(10) Pub. No.: US 2015/0051871 A1
(43) Pub. Date: Feb. 19, 2015

(54) EVALUATION DEVICE, SEMICONDUCTOR MANUFACTURING APPARATUS, CONTROL DEVICE, AND RECORDING MEDIUM

(71) Applicant: TOKYO ELECTRON LIMITED, Tokyo (JP)

(72) Inventor: Ryoko Mimura, Tokyo (JP)

(21) Appl. No.: 14/382,924

(22) PCT Filed: Feb. 5, 2013
(86) PCT No.: PCT/JP2013/052542

§ 371 Date: Sep. 4, 2014

(30) Foreign Application Priority Data
Mar. 7, 2012 (JP) 2012-050866

(51) Int. Cl. G05B 23/00; G01M 99/00

(52) U.S. Cl. CPC G05B 23/00; G01M 99/005
USPC 702/183

(57) ABSTRACT

Provided is a device of evaluating a semiconductor manufacturing apparatus in which flow rate control units are installed in flow paths through which gas supplied from gas supply sources flows, and an operation of each flow rate control unit is controlled according to time-serially defined process conditions to adjust a supply operation of gas in a semiconductor manufacturing process. The device includes: a storage unit to store layouts of the flow rate control units; an obtaining unit configured to obtain information of the process conditions at an instant of time; a specifying unit configured to specify an operational state of each flow rate control unit based on the information of the process conditions; and a determination unit configured to determine an internal gas state of a flow path arranged over upstream and downstream sides of each flow rate control unit based on the specified operational state and the layouts.

### CROSS-REFERENCE TO RELATED APPLICATIONS

This application is a 35 U.S.C §371 national stage filing of International Application No. PCT/JP2013/052542, filed Feb. 5, 2013, the entire contents of which are incorporated by reference herein, which claims priority to Japanese Patent Application No. 2002-050866, filed on Mar. 7, 2012, the entire contents of which are incorporated by reference herein.

### TECHNICAL FIELD

The present disclosure relates to a semiconductor manufacturing apparatus, an evaluation device for evaluating the same, a control device, and a non-transitory computer-readable recording medium.

### BACKGROUND

In a semiconductor manufacturing apparatus, in order to evaluate the validity of production or a maintenance recipe, or working conditions of the apparatus, it is required to check internal states of gas pipes for every step of each recipe. For example, it is necessary to check whether gas is being flown through a respective gas pipe, whether the respective gas pipe is in a vacuum state without any residual gas therein, or whether gas stays in the respective gas pipe at an instant of time.

To do this, in the related art, the production recipe or the maintenance recipe is checked for every step of a gas flow chart.

However, to check the internal states of the gas pipes in the semiconductor manufacturing apparatus requires checking an operational state of a mass flow controller installed in the respective gas pipe, opening/closing states of valves installed at upstream and downstream sides of the mass flow controller, a degree of opening of an automatic pressure controller and the like, while referring to the gas flow chart. This makes it difficult for a human being to check the internal state of the gas pipe.

In general, a plurality of mass flow controllers and a plurality of valves are installed in the gas pipes. This arrangement fails to check the internal states of the gas pipes while collectively checking a setting state of each of the mass flow controllers and the valves.

In addition, the internal states of the gas pipes depend on conditions of a previous step. This causes a problem that the internal states of the gas pipes should be sequentially checked starting from a first step. In the semiconductor manufacturing apparatus, the number of steps of a recipe ranges from approximately 20 to 100, and the types of gases (corresponding to the number of the mass flow controllers) are a dozen or more. As such, recognizing internal states of all the gas pipes by a human being is too complicated to be realistic.

### SUMMARY

The present disclosure provides some embodiments of an evaluation device which is capable of automatically determining internal gas states of gas pipes, a semiconductor manufacturing apparatus, control device and a non-transitory computer-readable recording medium.

According to one embodiment of the present disclosure, there is provided a device of evaluating a semiconductor manufacturing apparatus in which a plurality of flow rate control units are installed in flow paths through which gas supplied from one or more gas supply sources flows, and an operation of each of the flow rate control units is controlled according to time-serially defined process conditions to adjust a supply operation of gas in a semiconductor manufacturing process. The device includes a storage unit to store layouts of the flow rate control units; an obtaining unit configured to obtain information associated with the process conditions at an instant of time; a specifying unit configured to specify an operational state of each of the flow rate control units based on the obtained information associated with the process conditions; and a determination unit configured to determine an internal gas state of a flow path arranged over upstream and downstream sides of each of the flow rate control units based on the specified operational state and the layouts stored in the storage unit.

According to the present disclosure, layouts (connective relationships) of flow rate control units including various opening/closing valves, mass flow controllers, an automatic pressure controller, a vacuum pump and the like, are stored in the storage unit, and the operational state of each of the flow rate control units at each point in time is defined as the process conditions. Accordingly, the internal gas state of the gas pipe at the instant of time is determined by obtaining information of the layouts stored in the storage unit and information of the operational state of each of the flow rate control units, which can be specified based on the process conditions.

In the evaluation device according to the present disclosure, the flow rate control unit includes opening/closing valves configured to open/close the flow path, and a mass flow controller configured to control a flow rate of gas flowing through the flow path. The process conditions define opening/closing states of the opening/closing valves and an operational state of the mass flow controller.

According to the present disclosure, the opening/closing states of the opening/closing valves and the operational states of the flow rate controllers such as mass flow controllers are defined as the process conditions. Accordingly, the operational state of each of the flow rate control units at an instant of time is specified based on the process conditions.

In the evaluation device according to the present disclosure, the layouts are defined by a table in which identifiers of the mass flow controllers and identifiers of the opening/closing valves which are arranged at at least one of the upstream and downstream sides of each of the mass flow controllers, are registered to be mapped to each other.

According to the present disclosure, there is provided a table in which the identifiers of the flow rate controllers and the identifiers of the opening/closing valves arranged at the at least one of the upstream and downstream sides of each of the flow rate controllers are registered to be mapped to each other. Accordingly, the layouts between the flow rate control units and the opening/closing valves are specified with reference to the identifiers registered in the table.

In the evaluation device according to the present disclosure, the flow rate control unit further includes at least one of a pump configured to discharge gas within the flow path and a pressure controller configured to control an internal gas pressure of the flow path. The process conditions define an operational state of the pump or the pressure controller. The table stores an identifier of an opening/closing valve connected to the pump or the pressure controller through a flow path, and an identifier of another opening/closing valve not connected to the pump or the pressure controller, so as to be discriminated from each other.

According to the present disclosure, the operational states of the flow rate control unit including the at least one of the pump and the pressure controller are defined as the process conditions. Accordingly, the operational state of each of the flow rate control units at an instant of time is specified with reference to the process conditions. Further, since a connective relationship between the pump or the pressure controller and the opening/closing valves is defined in the table, it is possible to discriminate an opening/closing valve connected to the pump or the pressure controller and an opening/closing valve not connected to the pump and the pressure controller based on the identifiers registered in the table.

In the evaluation device according to the present disclosure, the determination unit is configured to determine whether the gas flows through the flow path. When the determination unit determines that the gas flows through the flow path, the determination unit measures a flow rate of the gas flowing through the flow path using a measurement unit; and outputs the measured flow rate using an output unit.

According to the present disclosure, when it is determined that the gas flows through the flow path, an actual gas flow rate is detected. Accordingly, stability or controllability of the gas flow rate is evaluated.

In the evaluation device according to the present disclosure, the determination unit is configured to determine whether the gas stays in the flow path. When the determination unit determines that none of the gas stays in the flow path, the determination unit detects a flow rate of the gas within the flow path using a detection unit; and outputs the detected flow rate using an output unit.

According to the present disclosure, when it is determined that none of the gas stays in the flow path, an actual gas flow rate is detected. Accordingly, a zero point evaluation of the flow rate controller can be performed.

In the evaluation device according to the present disclosure, the determination unit is configured to determine whether the gas stays in the flow path. When the determination unit determines that the gas stays in the flow path, the determination unit calculates a gas stay duration during which the gas stays in the gas path based on the process conditions using a calculation unit; and outputs the calculated gas stay duration using an output unit.

According to the present disclosure, when it is determined that the gas stays in the flow path, a gas stay duration during which the gas stays in the gas path is calculated. Accordingly, a corrosive gas stay duration during which a corrosive gas stays in the gas pipe is evaluated.

According to another embodiment of the present disclosure, there is provided a semiconductor manufacturing apparatus in which a plurality of flow rate control units are installed in flow paths through which gas supplied from one or more gas supply sources flows, and an operation of each of the flow rate control units is controlled according to time-serially defined process conditions such that a supply operation of gas in a semiconductor manufacturing process is adjusted. The apparatus includes: a storage unit to store layouts of the flow rate control units; an obtaining unit configured to obtain information according to the process conditions at an instant of time; a specifying unit configured to specify an operational state of each of the flow rate control units based on the obtained information according to the process conditions; and a determination unit configured to determine an internal gas state of each of flow paths installed at upstream and downstream sides of each of the flow rate control units based on the specified operational state and the layouts stored in the storage unit.

According to still another embodiment of the present disclosure, there is provided a control device of evaluating a semiconductor manufacturing apparatus in which a plurality of flow rate control units are installed in flow paths through which gas supplied from one or more gas supply sources flows, and an operation of each of the flow rate control units is controlled according to time-serially defined process conditions to adjust a supply operation of gas in a semiconductor manufacturing process, the control device to cause the apparatus to perform steps of: specifying an operational state of each of the flow rate control units based on the process conditions at an instant of time; and determining an internal gas state of a flow path arranged over upstream and downstream sides of each of the flow rate control units, based on the specified operational state and layouts of each of the flow rate control units which are pre-stored.

According to still another embodiment of the present disclosure, there is provided a non-transitory computer-readable recording medium storing a computer program for causing a computer to evaluate a semiconductor manufacturing apparatus in which a plurality of flow rate control units are installed in flow paths through which gas supplied from one or more gas supply sources flows, and an operation of each of the flow rate control units is controlled according to time-serially defined process conditions to adjust a supply operation of gas in a semiconductor manufacturing process, the program to cause the computer to execute steps of: specifying an operational state of each of the flow rate control units based on the process conditions at an instant of time; and determining an internal gas state of a flow path arranged over upstream and downstream sides of each of the flow rate control units, based on the specified operational state and layouts of each of the flow rate control units which are pre-stored.

According to the present disclosure, determination results of an internal gas state of a gas pipe at an instant of time are obtained through simulation by a computer, based on information of layouts (connective relationships) between flow rate control units including various opening/closing valves, mass flow controllers, an automatic pressure controller and a vacuum pump, and information of an operational state of each of the flow rate control units, which can be specified from the process conditions.

According to the present disclosure, it is possible to automatically determine a state of gas within a gas pipe, without sequentially checking respective steps defined in a production recipe or a maintenance recipe by a human being.

### BRIEF DESCRIPTION OF THE DRAWINGS

FIG. 1 is a schematic view showing an overall configuration of a system including a semiconductor manufacturing apparatus according to a first embodiment of the present disclosure.

FIG. 2 is a schematic view showing an example of a configuration of gas pipes in the semiconductor manufacturing apparatus.

FIG. 3 is a block diagram showing a hardware configuration of a server device.

FIG. 4 is a block diagram showing a functional configuration of a server device.

FIGS. 5A and 5B are views showing examples of an MFC table.

FIG. 6 is a schematic view showing a simplified configuration model of gas pipes.

FIG. 7 is a flow chart showing a sequence of processes executed by a server device.

FIG. 8 is a block diagram showing a functional configuration of a server device according to a second embodiment.

FIG. 9 is a block diagram showing a functional configuration of a server device according to a third embodiment.

FIG. 10 is a block diagram showing a functional configuration of a server device according to a fourth embodiment.

### DETAILED DESCRIPTION

Embodiments of the present disclosure will now be described in detail with reference to the drawings.

### First Embodiment

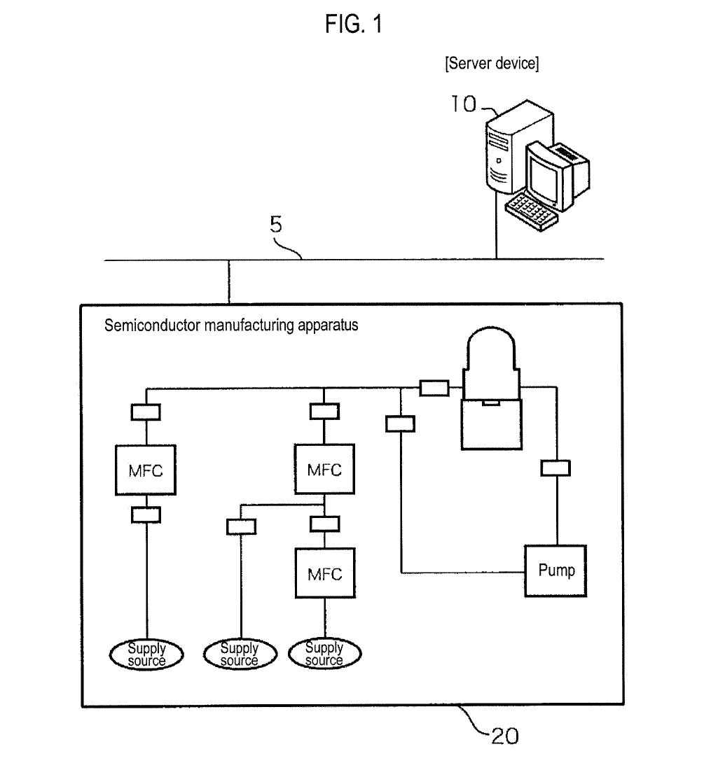

FIG. 1 is a schematic view showing an overall configuration of a system including a semiconductor manufacturing apparatus according to a first embodiment of the present disclosure. A semiconductor manufacturing apparatus 20 according to the first embodiment is a vertical furnace semiconductor manufacturing apparatus in which plural types of gases contributing to a film formation are flown into a vertical processing chamber to manufacture a semiconductor wafer.

A detailed configuration of the semiconductor manufacturing apparatus 20 will be described later. The semiconductor manufacturing apparatus 20 according to the first embodiment includes, for example, gas supply sources configured to supply the plural types of gases, gas pipes used as flow paths through which the gases supplied from the gas supply sources are flown, a plurality of flow rate control units properly installed in the gas pipes, a processing chamber configured to accommodate semiconductor wafers to be manufactured, and the like. The processing chamber is charged with the gases supplied from the gas supply sources. The flow rate control unit includes, for example, opening/closing valves configured to open/close a respective flow path, a mass flow controller (MFC) configured to control a flow rate of gas flowing through the respective gas pipe based on a mass flow rate of gas, a vacuum pump (PU) configured to discharge the gas within the respective gas pipe, an automatic pressure controller (APC) configured to control an internal gas pressure of the respective gas pipe, and the like.

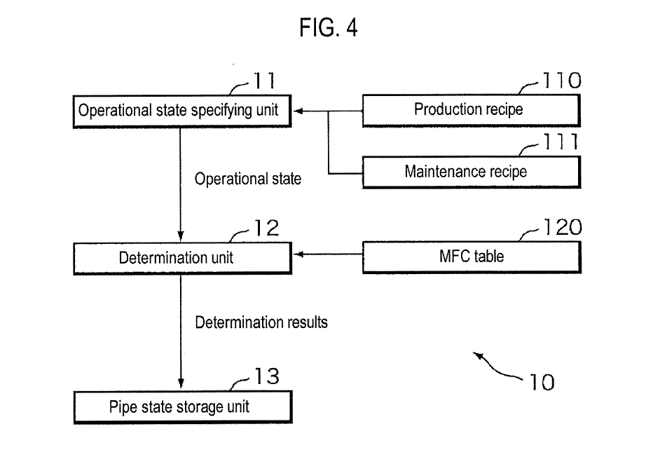

A server device 10 is connected to the semiconductor manufacturing apparatus 20 through a communication network 5 such as a LAN. The server device 10 serves to control an operation of the semiconductor manufacturing apparatus 20. To do this, the server device 10 includes a production recipe 110, a maintenance recipe 111 and the like stored therein (see FIG. 4).

The production recipe 110 includes time-serially defined process conditions for thermally treating the semiconductor wafers. In general, the production recipe 110 includes about 20 to 100 steps. Process conditions such as a type of gas, a flow rate of gas, an internal temperature and pressure of the processing chamber, are set in each of the steps. The server device 10 controls the operation of the semiconductor manufacturing apparatus 20 based on the process conditions set in each of the steps of the production recipe 110, thus allowing the semiconductor manufacturing apparatus 20 to manufacture the semiconductor wafers.

The maintenance recipe 111 is a recipe used to perform a maintenance service of the semiconductor manufacturing apparatus 20. For example, the maintenance recipe 111 includes conditions such as a type of gas, a flow rate of gas and a temperature, which are applied when cleaning the interior of the processing chamber, conditions applied when checking an operation of a drive unit (not shown) provided in the semiconductor manufacturing apparatus 20, and the like. These conditions are defined serially by time.

The server device 10 according to this embodiment further acts as an evaluation device for evaluating the semiconductor manufacturing apparatus 20, and includes a determination unit configured to determine an internal gas state of a respective gas pipe at an instant of time. With such a determination unit, the server device 10 can check, for example, whether the gas flows through the respective gas pipe, whether the gas stays in the respective gas pipe, whether the respective gas pipe is in a vacuum state without any residual gas therein, and the like.

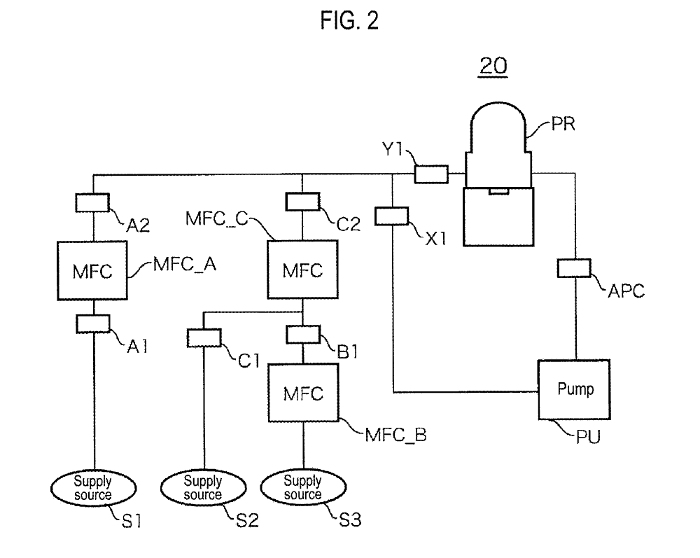

FIG. 2 is a schematic view showing an example of a configuration of gas pipes provided in the semiconductor manufacturing apparatus 20. In this example shown in FIG. 2, three gas supply sources S1 to S3 are provided. In a first flow path (or first gas pipe) extending from the first gas supply source S1 to a processing chamber PR, a valve A1, a mass flow controller MFC_A, a valve A2 and a valve Y1 are arranged in the named order. The valve Y1 is a valve (i.e., tube last valve) lastly arranged in the first flow path.

Further, in a second flow path (or second gas pipe) extending from the second gas supply source S2 to the processing chamber PR, a valve C1, a mass flow controller MFC_C, a valve C2 and the valve Y1 are arranged in the named order. Also, in a third flow path (or third gas pipe) extending from the third gas supply source S3 to the processing chamber PR, a mass flow controller MFC_B, a valve B1, the mass flow controller MFC_C, the valve C2 and the valve Y1 are arranged in the named order. As shown in FIG. 2, the second flow path extending from the second gas supply source S2 to the processing chamber PR and the third flow path extending from the third gas supply source S3 to the processing chamber PR are shared in a partial section.

A branch path is formed to extend starting at an upstream side of the valve Y1. A valve X1, the vacuum pump (PU) and the automatic pressure controller (APC) are arranged along the branch path in the named order. The valve X1 is connected to the vacuum pump PU which is configured to discharge gas residing inside a respective gas pipe coupled thereto. Thus, the valve X1 functions as an exhaust valve.

The configuration of the gas pipes shown in FIG. 2 is merely one example without being limited thereto. In some embodiments, the number of the gas supply sources, the number of the mass flow controllers, a connective relationship between the valves, and a connective relationship between the gas pipes may be varied in various ways.

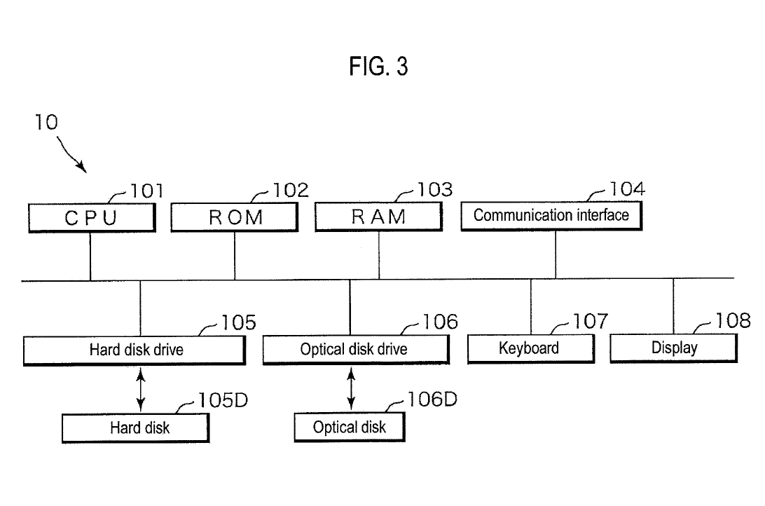

FIG. 3 is a block diagram showing a hardware configuration of the server device 10. The server device 10 includes a CPU 101, a ROM 102, a RAM 103, a communication interface 104, a hard disk drive 105, an optical disk drive 106, a keyboard 107 and a display 108.

The ROM 102 is configured to pre-store therein a computer program, which is required for controlling operations of respective parts of the hardware as described above. Further, the server device 10 includes a hard disk 105D which is configured to pre-store therein another computer program such that the server device 10 serves as the evaluation device according to the present disclosure.

The CPU 101 reads the computer program stored in the ROM 102 or another computer program stored in the hard disk 105D to the RAM 103, and executes the read program at a predetermined time. In this way, the CPU 101 controls the operations of the respective parts of the hardware as described above, thus enabling the server device 10 to operate as the evaluation device according to the present disclosure.

An example of the RAM 103 may include a dynamic RAM (DRAM), a static RAM (SRAM) or the like. The RAM 13 is configured to temporarily store various data (e.g., computation results, selection results or various parameters) while the CPU 101 executes the computer program or another computer program.

The communication interface 104 serves as a communication unit for communicating with the semiconductor manufacturing apparatus 20 through the communication network 5 shown in FIG. 1.

The hard disk drive 105 controls writing/reading operations of data in/out of the hard disk 105D. The hard disk drive 105 writes information received through the keyboard 107, information received from the communication interface 104, information read out of an optical disk 106D by the optical disk drive 106 and the like, in the hard disk 105D. In this way, various types of information are stored in the hard disk 105D.

In addition, the hard disk 105D is configured to pre-store therein the production recipe 110, the maintenance recipe 111 and an MFC table 120 (which will be described later), in addition to the foregoing computer programs and the various types of information.

The optical disk drive 106 controls writing/reading operations of data in/out of the optical disk 106D. While in this embodiment, the computer programs for realizing the evaluation device according to the present disclosure has been described to be stored in the hard disk 105D, the computer programs may be stored in the optical disk 106D.

The keyboard 107 receives commands (manipulation and character data) inputted by an operator. The display 108 displays information to be provided to the operator.

In some embodiments, the optical disk drive 106, the keyboard 107, the display 108 and the like may be omitted as long as the server device 10 can be remotely manipulated through the communication network 5.

FIG. 4 is a block diagram showing a functional configuration of the server device 10. The server device 10 includes an operational state specifying unit 11, a determination unit 12, and a pipe state storage unit 13. The operational state specifying unit 11 is configured to obtain process conditions from the production recipe 110 and the maintenance recipe 111 at an instant of time (at a certain step of a respective recipe). Based on the obtained process conditions, the operational state specifying unit 11 specifies an operational state of a respective flow rate control unit, i.e., opening/closing states of the valves, and operational states of the mass flow controller, the vacuum pump and the automatic pressure controller, at the instant of time. The operational state specifying unit 11 notifies the determination unit 12 of the specified operational state of the respective flow rate control unit.

Upon receipt of the specified operational state of the respective flow rate control unit provided from the operational state specifying unit 11, the determination unit 12 determinates an internal gas state of a gas pipe arranged over upstream and downstream sides of the respective mass flow controller with reference to the MFC table 120. The MFC table 120 is a table in which layouts of the mass flow controllers are stored, which will be described later.

The pipe state storage unit 13 is configured to store therein the internal gas state of the gas pipe in a respective step, which is determined at the determination unit 12.

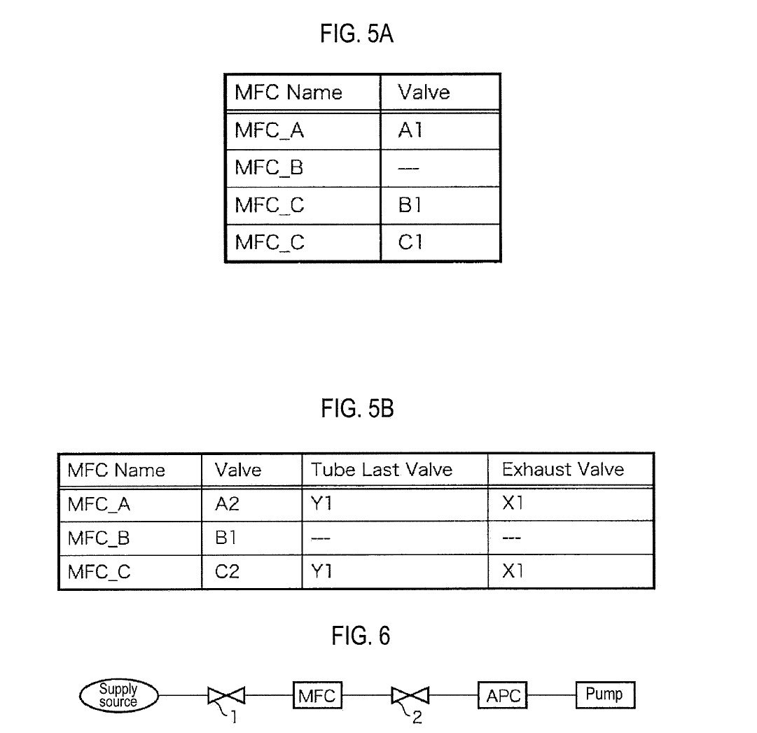

FIGS. 5A and 5B are views showing examples of the MFC table 120. FIG. 5A shows a primary side MFC table which represents a layout relationship between identifiers of the respective mass flow controllers and identifiers of the respective valves arranged at primary sides (upstream sides) of the respective mass flow controllers.

As shown in the configuration example of the gas pipes shown in FIG. 2, the valve A1 is arranged at the upstream side of the mass flow controller MFC_A in the first gas pipe. Accordingly, in the primary side MFC table shown in FIG. 5A, the identifier of the mass flow controller “MFC_A” and the identifier of the valve “A1” are registered to be mapped to each other so that a layout relationship therebetween is identified. The other mass flow controllers are also similar. In the primary side MFC table of FIG. 5A, no valve is arranged at the upstream side of the mass flow controller MFC_B in the third gas pipe, and two valves B1 and C1 are arranged at the upstream sides of the mass flow controller MFC_C in the second and third gas pipes.

FIG. 5B shows a secondary side MFC table which represents a layout relationship between the identifiers of the respective mass flow controllers and the identifiers of the respective valves arranged at secondary sides (downstream sides) of the respective mass flow controllers.

As shown in the configuration example of the gas pipes shown in FIG. 2, the valves A2, Y1 and X1 are arranged at the downstream side of the mass flow controller MFC_A in the first gas pipe. Accordingly, in the secondary side MFC table, the identifier of the mass flow controller “MFC_A” and the identifiers of the valves “A2”, “Y1”, and “X1” are registered to be mapped to each other. Further, in this embodiment, the valve “Y1” arranged at the most downstream side of the first gas pipe and the valve “X1” connected to the vacuum pump PU are registered to be discriminated from the other valves. For example, the valve Y1 is registered in a section of “Tube Last Valve” as one arranged at the most downstream side of the first gas pipe, and the valve X1 is registered in a section of “Exhaust Valve” as one connected to the vacuum pump PU.

The other mass flow controllers are also similar. Only the valve B1 is arranged at the downstream side of the mass flow controller MFC_B in the third gas pipe. Thus, the identifier of the mass flow controller “MFC_B” and the identifier of the valve “B1” are registered to be mapped to each other. Since the valve Y1 arranged at the most downstream side of the first gas pipe and the valve X1 connected to the vacuum pump PU are not provided at the downstream side of the mass flow controller MFC_B, the sections of “Tube Last Valve” and “Exhaust Valve” corresponding to mass flow controller MFC_B are blanks.

Also, since the valves C2, Y1, and X1 are arranged at the downstream side of the mass flow controller MFC_C, the identifier of the mass flow controller “MFC_C” and the identifiers of the valves “C2”, “Y1” and “X1” are registered to be mapped to each other. Since the valve Y1 is arranged at the most downstream side of the first gas pipe, the identifier thereof “Y1” is registered in the section of “Tube Last Valve.” Since the valve X1 is connected to the vacuum pump PU, the identifier thereof “X1” is registered in the section of “Exhaust Valve.”

For example, as can be seen from the column of “MFC_B” in the primary side MFC table of FIG. 5A, there exists no valve between the mass flow controller MFC_B and the gas supply source S3. Also, as can be seen from the column of “MFC_B” in the secondary side MFC table of FIG. 5B, no identifiers of valves are registered in the sections of “Tube Last Valve” and “Exhaust Valve”. This represents that another mass flow controller has been connected to the mass flow controller MFC_B. The mass flow controller MFC_B having the valve identifier “B1” arranged at the downstream side thereof in the secondary side MFC table of FIG. 5B corresponds to the mass flow controller MFC_C in the primary side MFC table of FIG. 5A. Thus, it can be appreciated that the mass flow controller MFC_C is arranged at the downstream side of the mass flow controller MFC_B.

In addition, for example, as shown in the columns “MFC_A” and “MFC_C” in the secondary side MFC table of FIG. 5B, the identifiers of the valves “Y1” and “X1” registered in the sections of “Tube Last Valve” and “Exhaust Valve” are identical to each other. Thus, it can be appreciated that the mass flow controllers MFC_A and MFC_C are coupled to a common gas pipe in which at least a portion of the first and second gas pipes is shared by each other.

With the MFC table 120 configured as above, the server device 10 can obtain information of the layouts between the mass flow controllers and the valves when the foregoing computer program is executed. The server device 10 determines the internal gas state of the respective gas pipe using the MFC table 120 and the production recipe 110 (or the maintenance recipe 111).

Next, a determination method performed by the server device 10 will be described. FIG. 6 is a schematic view showing an example of a simplified configuration model of gas pipes. In the example shown in FIG. 6, a valve 1 is arranged in a primary gas pipe extending from a gas supply source to a mass flow controller (MFC). A valve 2, an automatic pressure controller (APC) and a pump are arranged in that order in a secondary gas pipe arranged to extend starting at a downstream side of the MFC. It should be noted that the example of FIG. 6 does not show the configuration example of the gas pipes shown in FIG. 2.

Based on the production recipe 110 (or the maintenance recipe 111), the server device 10 can obtain information associated with an opening/closing state of each of the valves 1 and 2, and operational states of the MFC, the APC and the vacuum pump at an instant of time.

In this configuration, assuming that a previous step is in “a state where gas flows”, when a current step is in a state where the valve 1 and the MFC are closed, and the valve 2 and the APC are opened, the server device 10 determines that the primary gas pipe between the valve 1 and the MFC is in “a state where gas stays therein”. Further, the server device 10 determines that the secondary gas pipe between the MFC and the valve 2 is in “a state where none of the gas stays therein” with the operation of the vacuum pump.

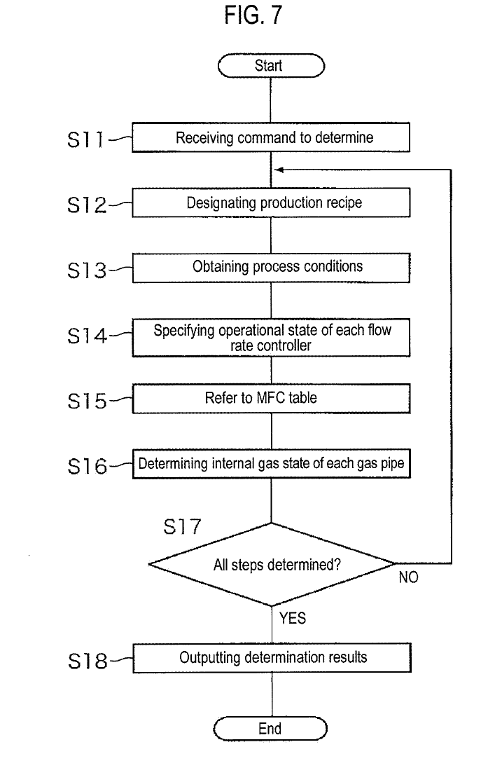

FIG. 7 is a flow chart showing a sequence of processes executed by the server device 10. The server device 10 receives a command to determine an internal gas state of a respective gas pipe through the keyboard 107 (in step S11). In some embodiments, an operator may designate to determine a state of gas at any point in time (at a certain step of a respective recipe).

The operational state specifying unit 11 designates the production recipe 110 (or the maintenance recipe 111) as a target to be determined (in step S12), and obtains process conditions defined by the production recipe 110 (in step S13). Subsequently, the operational state specifying unit 11 specifies an operational state of each of the flow rate control units, i.e., opening/closing states of the valves, and operational states of the mass flow controllers, the vacuum pump and the automatic pressure controller, based on the obtained process conditions (in step S14). The operational state specifying unit 11 notifies the determination unit 12 of the specified operational state of each of the flow rate control units.

Upon receipt of the specified operational state of each of the flow rate control units provided from the operational state specifying unit 11, the determination unit 12 determines an internal gas state of each of the flow paths arranged at upstream and downstream sides of each of the mass flow controllers using the MFC table 120 (in steps S15 and S16). In some embodiments, the determination unit 12 may utilize a state of gas in the previous step stored in the pipe state storage unit 13.

Subsequently, the determination unit 12 stores the state of gas obtained by the above determination operation in the pipe state storage unit 13, and determines whether the determination operation has been performed on all the steps (in step S17). If the result of the determination is negative (NO in step S17), the determination operation of the determination unit 12 returns step S12.

If it is determined that the determination operation has been performed on all the steps (YES in step S17), the determination unit 12 outputs the determination results (in step S18). As an example, the determination results may be outputted as character information to be displayed on the display 108. If the server device 10 performs a further process using the determination results, the determination results may be provided to a respective processing unit as process data. Alternatively, the determination results may be transmitted to an external device through the communication interface 104.

In some embodiments, determination results obtained during all the steps may be outputted. Alternatively, determination results obtained at only a step designated by the operator may be outputted.

As described above, according to the first embodiment, in monitoring the internal gas state of the gas pipe, the operator does not need to perform the determination operation while checking every step with reference to the gas flow chart, which makes it possible to significantly reduce the workload of the operator.

### Second Embodiment

While in the first embodiment, the internal gas state of the gas pipe has been described to be determined at an instant of time, the present disclosure is not limited thereto. In some embodiments, when it is determined that none of the gas stays in the gas pipe, a flow rate of gas at that time may be measured such that a zero point evaluation of the mass flow controller is performed.

The second embodiment relates to a configuration in which the zero point evaluation of the mass flow controller is performed, which will be described later. Also, an overall configuration of the system and a hardware configuration of the server device 10 are identical to those of the first embodiment, and therefore, descriptions thereof will be omitted.

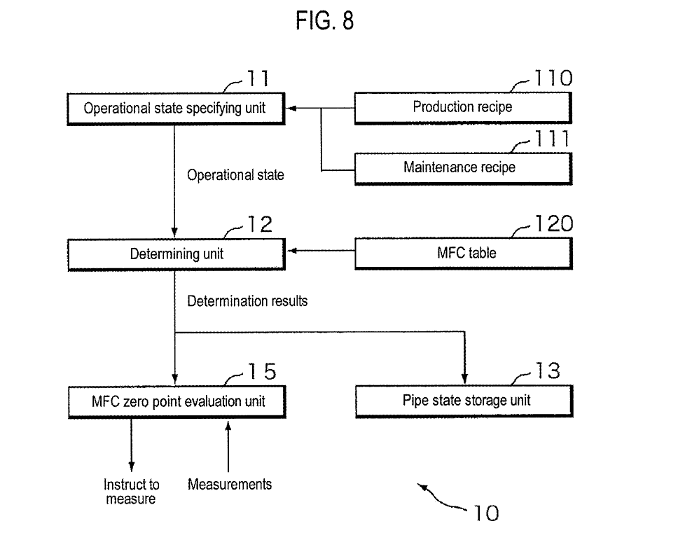

FIG. 8 is a block diagram showing a functional configuration of the server device 10 according to the second embodiment. The server device 10 includes an MFC zero point evaluation unit 15, in addition to the operational state specifying unit 11, the determination unit 12 and the pipe state storage unit 13 as described above in the first embodiment.

The operational state specifying unit 11 obtains process conditions of a respective step from the production recipe 110 or the maintenance recipe 111, and specifies an operational state of a respective flow rate control unit, including opening/closing states of the valves, and operational states of the mass flow controller, the vacuum pump and the automatic pressure controller based on the obtained process conditions. The operational state specifying unit 11 notifies the determination unit 12 of the specified operational state of the respective flow rate control unit.

Upon receipt of the specified operational state of the respective flow rate control unit provided from the operational state specifying unit 11, the determination unit 12 determines an internal gas state of a flow path arranged over upstream and downstream sides of the respective mass flow controller with reference to the MFC table 120. The determination unit 12 stores the determination results in the pipe state storage unit 13, and also notifies the MFC zero point evaluation unit 15 of the determination results.

When the determination results provided from the determination unit 12 indicate that the gas pipe is in a vacuum state without any residual gas therein, the MFC zero point evaluation unit 15 issues a command to instruct the semiconductor manufacturing apparatus 20 to measure a flow rate of gas within the gas pipe. The semiconductor manufacturing apparatus 20 measures the flow rate of the gas within the gas pipe using a gas flow rate measurement unit (not shown), and returns the measurements to the MFC zero point evaluation unit 15.

The MFC zero point evaluation unit 15 performs a zero point evaluation based on the measurements obtained at the gas flow rate measurement unit. Specifically, the MFC zero point evaluation unit 15 outputs, as an evaluation value, a gas flow rate obtained at an instant of time at which the gas flow rate should be zero ideally. In some embodiments, the MFC zero point evaluation unit 15 may output, as evaluation results, an index indicating a magnitude of the gas flow rate which is obtained at the instant of time at which the gas flow rate should be zero ideally.

### Third Embodiment

While in the first embodiment, the internal gas state of the gas pipe has been described to be determined at an instant of time, the present disclosure is not limited thereto. In some embodiments, when it is determined that gas circulates through the gas pipe, a gas flow rate in the gas pipe may be measured to measure a flow rate stability (flow rate controllability) of the mass flow controller.

The third embodiment relates to a configuration in which the flow rate stability (the flow rate controllability) of the mass flow controller is evaluated, which will be described later. Also, an overall configuration of the system and a hardware configuration of the server device 10 are identical to those of the first embodiment, and therefore, descriptions thereof will be omitted.

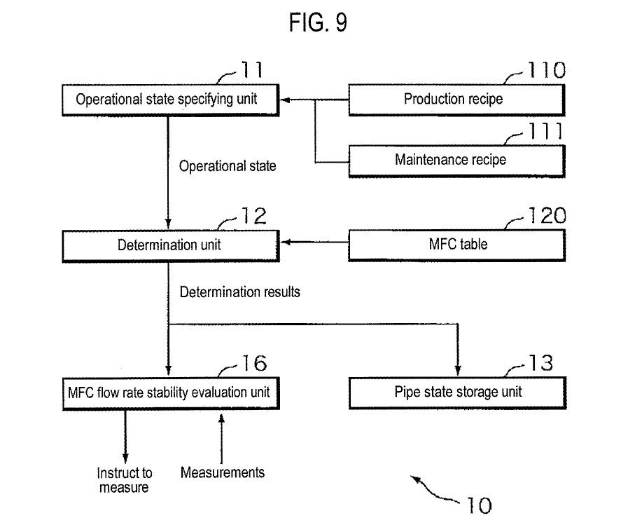

FIG. 9 is a block diagram showing a functional configuration of the server device 10 according to the third embodiment. The server device 10 includes an MFC flow rate stability evaluation unit 16, in addition to the operational state specifying unit 11, the determination unit 12 and the pipe state storage unit 13 as described above in the first embodiment.

The operational state specifying unit 11 obtains process conditions of a respective step from the production recipe 110 or the maintenance recipe 111, and specifies an operational state of a respective flow rate control unit, including opening/closing states of the valves and operational states of the mass flow controller, the vacuum pump and the automatic pressure controller based on the obtained process conditions. The operational state specifying unit 11 notifies the determination unit 12 of the specified operational state of the respective flow rate control unit.

Upon receipt of the specified operational state of the respective flow rate control unit provided from the operational state specifying unit 11, the determination unit 12 determines an internal gas state of a flow path arranged over upstream and downstream sides of the respective mass flow controller with reference to the MFC table 120. The determination unit 12 stores the determination results in the pipe state storage unit 13, and also notifies the MFC flow rate stability evaluation unit 16 of the determination results.

When the determination results provided from the determination unit 12 indicate that a gas circulates through the gas pipe, the MFC flow rate stability evaluation unit 16 issues a command to instruct the semiconductor manufacturing apparatus 20 to measure a flow rate of gas within the gas pipe. The semiconductor manufacturing apparatus 20 measures a gas flow rate within the gas pipe using a gas flow rate measurement unit (not shown), and returns the measurements to the MFC flow rate stability evaluation unit 16.

The MFC flow rate stability evaluation unit 16 evaluates a flow rate stability based on the measurements obtained at the gas flow rate measurement unit. Specifically, the MFC flow rate stability evaluation unit 16 outputs, as an evaluation value, a gas flow rate obtained in a step of the recipe, which is determined when the gas circulates through the gas pipe.

### Fourth Embodiment

While in the first embodiment, the internal gas state of the gas pipe has been described to be determined at an instant of time, the present disclosure is not limited thereto. In some embodiments, when it is determined that gas stays in a gas pipe, a stay duration during which the gas stays in the gas pipe may be calculated to evaluate a corrosive gas stay duration during which a corrosive gas stays in the gas pipe.

The fourth embodiment relates to a configuration in which the corrosive gas stay duration is evaluated, which will be described later. Also, an overall configuration of the system and a hardware configuration of the server device 10 are identical to those of the first embodiment, and therefore, descriptions thereof will be omitted.

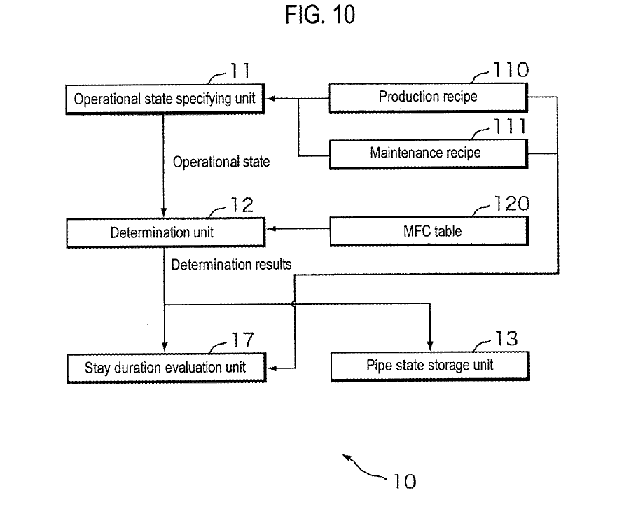

FIG. 10 is a block diagram showing a functional configuration of the server device 10 according to the fourth embodiment. The server device 10 includes a stay duration evaluation unit 17, in addition to the operational state specifying unit 11, the determination unit 12 and the pipe state storage unit 13 as described above in the first embodiment.

The operational state specifying unit 11 obtains process conditions of a respective step from the production recipe 110 or the maintenance recipe 111, and specifies an operational state of a respective flow rate control unit, including opening/closing states of the valves and operational states of the mass flow controller, the vacuum pump and the automatic pressure controller based on the obtained process conditions. The operational state specifying unit 11 notifies the determination unit 12 of the specified operational state of the respective flow rate control unit.

Upon receipt of the specified operational state of the respective flow rate control unit provided from the operational state specifying unit 11, the determination unit 12 determines an internal gas state of a flow path arranged over upstream and downstream sides of a respective mass flow controller with reference to the MFC table 120. The determination unit 12 stores the determination results in the pipe state storage unit 13, and also notifies the stay duration evaluation unit 17 of the determination results.

When the determination results provided from the determination unit 12 indicate that the gas pipe is in a state where gas stays therein, the stay duration evaluation unit 17 calculates a stay duration of the gas with reference to a recipe (the production recipe 110 or the maintenance recipe 111) which describes a step as a target to be determined. The stay duration evaluation unit 17 outputs the calculated gas stay duration as an evaluation value.

In some embodiments, evaluation of the gas stay duration may be performed only on gas that causes the gas pipe to be corrosive.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

1-8. (canceled)

9. A device of evaluating a semiconductor manufacturing apparatus in which a plurality of flow rate control units are installed in flow paths through which gas supplied from one or more gas supply sources flows, and an operation of each of the flow rate control units is controlled according to time-serially defined process conditions to adjust a supply operation of gas in a semiconductor manufacturing process, the device comprising:
a storage unit to store layouts of the flow rate control units;
an obtaining unit configured to obtain information associated with the process conditions at an instant of time;
a specifying unit configured to specify an operational state of each of the flow rate control units based on the obtained information associated with the process conditions; and
a determination unit configured to determine an internal gas state of a flow path arranged over upstream and downstream sides of each of the flow rate control units based on the specified operational state and the layouts stored in the storage unit.

10. The device of claim 9, wherein the flow rate control unit includes opening/closing valves configured to open/close the flow path, and a mass flow controller configured to control a flow rate of gas flowing through the flow path,
wherein the process conditions define opening/closing states of the opening/closing valves and an operational state of the mass flow controller.

11. The device of claim 10, wherein the layouts are defined by a table in which identifiers of the mass flow controllers and identifiers of the opening/closing valves which are arranged at at least one of the upstream and downstream sides of each of the mass flow controllers, are registered to be mapped to each other.

12. The device of claim 11, wherein the flow rate control unit further includes at least one of a pump configured to discharge gas within the flow path and a pressure controller configured to control an internal gas pressure of the flow path,
wherein the process conditions define an operational state of the at least one of the pump and the pressure controller,
wherein the table stores an identifier of an opening/closing valve connected to the at least one of the pump and the pressure controller through a flow path, and an identifier of another opening/closing valve not connected to the pump or the pressure controller, so as to be discriminated from each other.

13. The device of claim 9, wherein the determination unit is configured to determine whether the gas flows through the flow path, and
wherein, when the determination unit determines that the gas flows through the flow path, the determination unit measures a flow rate of the gas flowing through the flow path using a measurement unit; and outputs the measured flow rate using an output unit.

14. The device of claim 9, wherein the determination unit is configured to determine whether the gas stays in the flow path,
wherein, when the determination unit determines that none of the gas stays in the flow path, the determination unit detects a flow rate of the gas within the flow path using a detection unit; and outputs the detected flow rate using an output unit.

15. The device of claim 9, wherein the determination unit is configured to determine whether the gas stays in the flow path,
wherein, when the determination unit determines that the gas stays in the flow path, the determination unit calculates a gas stay duration during which the gas stays in the gas path based on the process conditions using a calculation unit; and outputs the calculated gas stay duration using an output unit.

16. A semiconductor manufacturing apparatus in which a plurality of flow rate control units are installed in flow paths through which gas supplied from one or more gas supply sources flows, and an operation of each of the flow rate control units is controlled according to time-serially defined process conditions such that a supply operation of gas in a semiconductor manufacturing process is adjusted, the apparatus comprising:
a storage unit to store layouts of the flow rate control units;
an obtaining unit configured to obtain information according to the process conditions at an instant of time;
a specifying unit configured to specify an operational state of each of the flow rate control units based on the obtained information according to the process conditions; and
a determination unit configured to determine an internal gas state of each of flow paths installed at upstream and downstream sides of each of the flow rate control units based on the specified operational state and the layouts stored in the storage unit.

17. A control device of evaluating a semiconductor manufacturing apparatus in which a plurality of flow rate control units are installed in flow paths through which gas supplied from one or more gas supply sources flows, and an operation of each of the flow rate control units is controlled according to time-serially defined process conditions to adjust a supply operation of gas in a semiconductor manufacturing process, the control device to cause the apparatus to perform steps of:
specifying an operational state of each of the flow rate control units based on the process conditions at an instant of time; and
determining an internal gas state of a flow path arranged over upstream and downstream sides of each of the flow rate control units, based on the specified operational state and layouts of each of the flow rate control units which are pre-stored.

18. A non-transitory computer-readable recording medium storing a computer program for causing a computer to evaluate a semiconductor manufacturing apparatus in which a plurality of flow rate control units are installed in flow paths through which gas supplied from one or more gas supply sources flows, and an operation of each of the flow rate control units is controlled according to time-serially defined process conditions to adjust a supply operation of gas in a semiconductor manufacturing process, the program to cause the computer to execute steps of:
specifying an operational state of each of the flow rate control units based on the process conditions at an instant of time; and
determining an internal gas state of a flow path arranged over upstream and downstream sides of each of the flow rate control units, based on the specified operational state and layouts of each of the flow rate control units which are pre-stored.
